(19) United States
(12) Patent Application Publication
(10) Pub. No.: US 2014/0078525 A1
(43) Pub. Date: Mar. 20, 2014

(54) IMAGE PROCESSING APPARATUS, IMAGE PROCESSING METHOD, AND COMPUTER READABLE MEDIUM

(71) Applicant: FUJI XEROX CO., LTD., Tokyo (JP)

(72) Inventors: Yuki HARA, Kanagawa (JP); Takashi KONDO, Kanagawa (JP)

(73) Assignee: FUJI XEROX CO., LTD., Tokyo (JP)

(21) Appl. No.: 13/739,192

(22) Filed: Jan. 11, 2013

(30) Foreign Application Priority Data
Sep. 18, 2012 (JP) 2012-204546

(51) Int. Cl. H04N 1/60

(52) U.S. Cl. CPC H04N 1/60
USPC 358/1.9

(57) ABSTRACT

An image processing apparatus includes an object inserting unit, a spot color converting unit, and a color conversion processing unit. The object inserting unit calculates, in a case where a designation for overprinting a first object on a second object is made, the position and shape of an overlap portion and a color value representing the color of the overlap portion using a process color, generates a third object having the calculated position, shape, and color value, and inserts the third object into print image data with a designation of knockout. The spot color converting unit converts the color value of the first object represented using the spot color into a color value represented using a process color. The color conversion processing unit performs color conversion processing for the color values of the first object, the second object, and the third object and outputs the color-converted print image data.

### CROSS-REFERENCE TO RELATED APPLICATIONS

This application is based on and claims priority under 35 USC 119 from Japanese Patent Application No. 2012-204546 filed Sep. 18, 2012.

### BACKGROUND

(i) Technical Field

The present invention relates to an image processing apparatus, an image processing method, and a computer readable medium.

(ii) Related Art

Various processing methods used for the case where overprinting is designated for a spot-color object have been available.

In one method, at the stage of page description language data (hereinafter, referred to as “PDL data”), color designation of an object using a spot color name is converted into color designation using process colors, using the relationship between the spot color name and process colors (for example, cyan (C), magenta (M), yellow (Y), and black (K)). Then, for the color designation of individual objects in the PDL data using process colors, color conversion for printing with a printing device such as a color matching system (CMS) is performed. At the time of rasterization of the color-converted PDL data, overprinting processing for objects is performed. In this method, color conversion is performed for individual objects, and individual color conversion results of overlapping objects are added for overprinting. In this method, since color conversion is performed in units of objects, color conversion processing is performed at high speed. However, since color conversion such as the CMS has nonlinear characteristics, when individually color-converted objects are overprinted, the color of the overprinted portion may be deviated from an assumed color (that is, the color to be obtained by performing color composition by overprinting and then performing color conversion).

In another method, at the time of rasterization of PDL data, rasterization is performed for spot-color versions as well as process-color versions. Then, the obtained raster images of the individual versions are collected and color conversion such as the CMS is performed. Then, raster images of the individual versions including the color-converted spot colors are combined together, and a raster image of only process colors is generated. In this method, since raster images of individual versions are collected and then color conversion is performed, the color conversion result of an overprinted portion achieves an assumed color. However, since the number of raster image versions increases as the number of spot colors increases, a high capacity memory is used. Furthermore, since color conversion is performed in units of pixels, color conversion processing is performed slowly compared to the method in which color conversion is performed in units of objects.

### SUMMARY

According to an aspect of the invention, there is provided an image processing apparatus including an object inserting unit, a spot color converting unit, and a color conversion processing unit. The object inserting unit calculates, in a case where in print image data in which objects are each represented by a combination of position, shape, and color value, a designation for overprinting a first object whose color value is represented using a spot color on a second object whose color value is represented using a process color is made, the position and the shape of an overlap portion where the first object and the second objet overlap and a color value representing the color of the overlap portion using a process color, generates a third object having the calculated position, shape, and color value, and inserts the generated third object into the print image data with a designation of knockout. The spot color converting unit converts the color value of the first object in the print image data represented using the spot color into a color value represented using a process color. The color conversion processing unit performs color conversion processing for the color values of the first object, the second object, and the third object in the print image data, the color values being represented using process colors, and outputs the color-converted print image data.

### BRIEF DESCRIPTION OF THE DRAWINGS

Exemplary embodiment of the present invention will be described in detail based on the following figures, wherein:

FIG. 1 is a diagram illustrating an example of the configuration of an apparatus according to an exemplary embodiment;

FIG. 2 is a diagram for explaining the overview of processing in the exemplary embodiment;

FIG. 3 is a diagram for explaining processing representing overprinting of a spot-color object on a normal object by a combination of these objects and an overlap portion object;

FIG. 4 is a diagram illustrating an example of the processing procedure of merging and object insertion by an intermediate data processing unit;

FIG. 5 is a diagram illustrating an example of the procedure of overprinting processing of the processing procedure illustrated in FIG. 4; and

FIG. 6 is a diagram illustrating an example of the procedure of processing for generating an overlap portion object of the processing procedure illustrated in FIG. 5.

### DETAILED DESCRIPTION

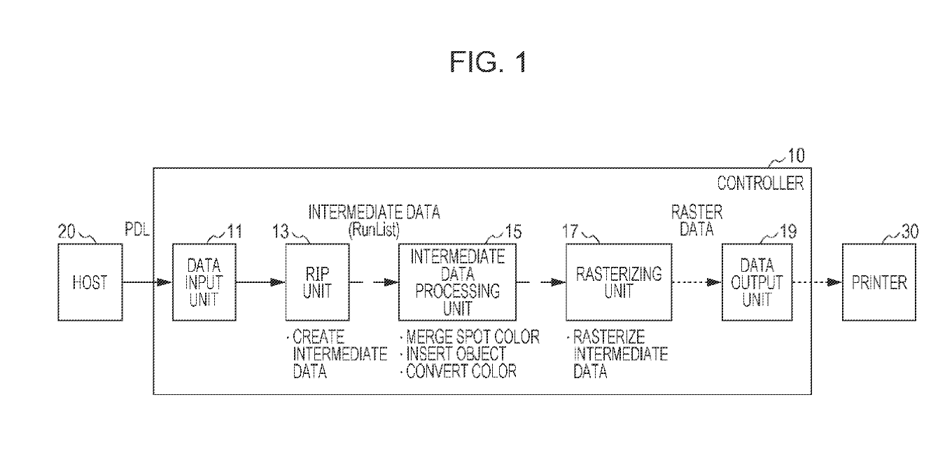

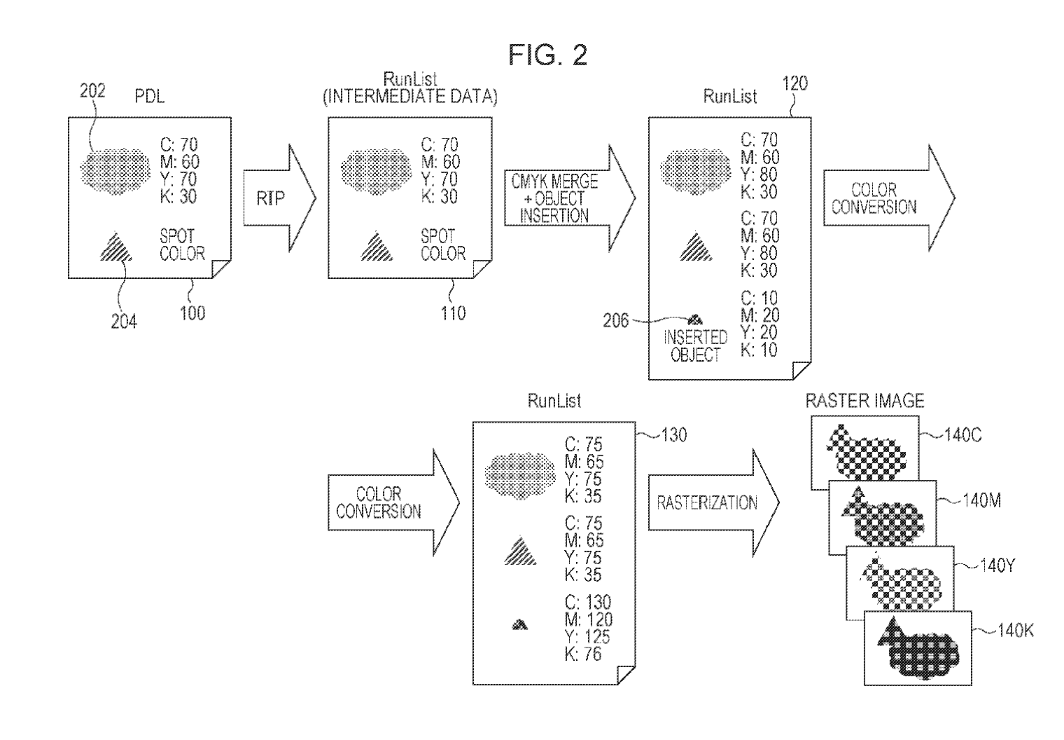

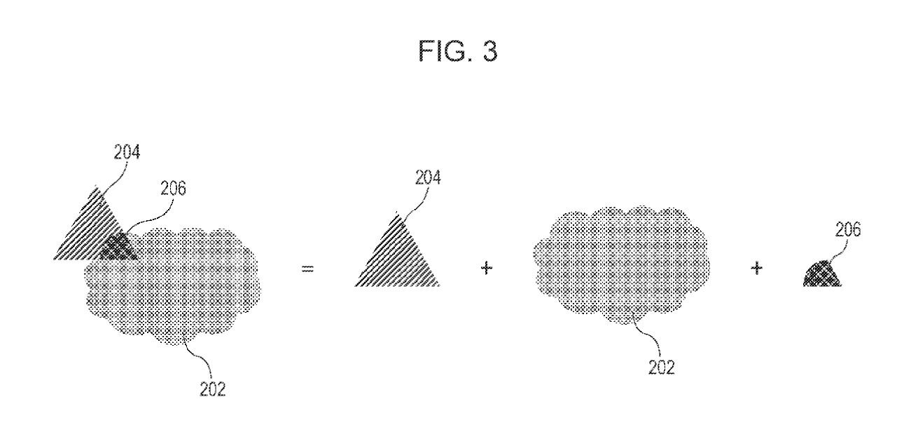

FIG. 1 illustrates the configuration of a controller 10 having an overprinting processing function in an exemplary embodiment. FIG. 2 is a diagram for explaining the overall flow of processing in the exemplary embodiment. FIG. 3 illustrates an example of overprinting of an object included in print data illustrated in FIG. 2. Hereinafter, processing of this exemplary embodiment will be explained with reference to these figures.

The controller 10 illustrated in FIG. 1 is a device that receives print data 100 (see FIG. 2) described in the PDL from a host 20 such as a personal computer and that converts the print data 100 into raster data 140C, 140M, 140Y, and 140K (see FIG. 2) that are to be handled by a printer 30. In the processing of conversion into raster data, processing regarding overprinting for a process-color object and a spot-color object is performed. The flow of the above-mentioned processing will be explained in detail below. In the explanation provided below, the print data 100, intermediate data 110 to 130, the raster data 140C, 140M, 140Y, and 140K represent a one-page image. Since overprinting occurs between objects on the same page, discussing data for one page is sufficient.

In the controller 10, a data input unit 11 receives from the host 20 the print data 100 in which images of individual pages to be printed are described in the PDL.

A raster image processor (RIP) unit 13 converts the print data 100 into the intermediate data 110 (see FIG. 2) in a data format between the PDL and the raster data.

In this exemplary embodiment, as the format of intermediate data, a RunList format is used in which individual objects (such as a character font, a graphics figure, continuous images), which are image elements forming an image, are each represented as a set of runs divided by scanning lines of raster scanning. For data in the RunList format, objects included in an image are each represented as a set (list) of runs, and images in one page are represented as a set of RunLists of individual objects. Each run defines a section of an object which occupies a scanning line. Data representing a run includes the addresses of the coordinates of the start point and the end point of the run and the pixel value attributes of the run (the pixel value in the case of a character or a graphics image, and images mapped in the run in the case of continuous images, that is, in this example, the entity of an image is stored in a different place) and the like. Furthermore, the intermediate data in the RunList format includes, as attribute information of an object including a set of runs, information representing the type of the object (such as a character, a graphics image, continuous images, etc.), information representing execution or non-execution of overprinting (of the object with respect to an underlying object), information specifying the bounding box of the object, and the like (here, the attributes such as the type of the object and information representing the execution or non-execution of overprinting may be included in data of individual runs of the object). The state of “non-execution of overprinting” is also called “knockout”. Furthermore, a bounding box represents a rectangular (sides are in parallel to the vertical or horizontal direction of a page) region containing the object. For example, in PDL data, information specifying a bounding box (for example, the coordinates of the upper-left and lower-right vertices of a bounding box) is set as attribute information of the object. Such information on a bounding box in PDL data may be embedded into intermediate data.

Using the RunList format for intermediate data is merely an example. Needless to say, a different format such as a display list format may be used. Intermediate data may have any format that defines the shape and color of each object (here, the object is defined in the data format of the intermediate data and may not be the same as an object of PDL data) included in a page. Since intermediate data having any format is closer to a raster format than PDL, calculation of the shape of a portion where objects overlap is performed at high speed compared to the case where the PDL is directly handled.

Here, as illustrated in FIGS. 2 and 3, it is assumed that in the input print data 100, a designation for rendering an image is made in which a spot-color object 204 whose color value (pixel value) is specified using a spot color is partially superimposed on a normal object 202 whose color value is specified using a process color with designation of overprinting (that is, “execution of overprinting”). Although a process color is typically represented by a combination of four components of CMYK, one or more color components such as orange may be added. Hereinafter, an example in which a process color is represented by a combination of four components of CMYK will be explained. A spot color is a specially defined color and is not a combination of process color components. For example, spot color ink manufacturers such as DIC Corporation and PANTONE® Inc. provide color samples of spot colors. On PDL data, a spot color is specified using the name of the spot color that is named by a spot color ink manufacturer (for example, “PANTONE 100”). Spot color ink manufactures provide, as information defining a spot color, information on the color value expressed in a color space that does not depend on a device (that is, a color space that does not depend on an output device, such as L*a*b or ideal CMYK not depending on a device). In many cases, a spot color is not completely expressed using process colors. With the use of the above-mentioned provided information, an approximate color is reproduced even with a printer or a display device that does not use the spot color.

For avoidance of complexity, the normal object 202 and the spot-color object 204 do not overlap in FIG. 2. In actuality, however, the normal object 202 and the spot-color object 204 partially overlap, as illustrated in FIG. 3.

Here, “overprinting” defines a method for representing the color of a portion where upper and lower objects overlap as the color obtained by combining the color of the upper object and the color of the lower object together. When “execution of overprinting” is designated, the color of the portion where the upper and lower objects overlap is represented as the color obtained by blending (mixing) the colors of the upper and lower objects. Meanwhile, when “non-execution of overprinting”, that is, “knockout” is designated, the color of the lower object is completely ignored and the color of the overlap portion is represented as the color of the upper object.

It is assumed that the PDL print data 100 created by a personal computer or the like includes designation for overprinting the spot-color object 204 on the normal object 202, as illustrated in FIG. 2.

In order to convert the print data 100 transmitted from the host 20 into raster data that is to be handled by the printer 30, color values represented in the print data 100 are converted into color values corresponding to the color reproduction characteristics unique to the printer 30. Such conversion includes color space conversion such as conversion from RGB into CMYK, color calibration (color correction) for matching the color reproduction characteristics of the printer 30 at that time, and the like. In this exemplary embodiment, processing for appropriately performing such color conversion even in the case where overprinting is performed (that is, the color of an overprint portion after the color conversion is performed is visually substantially the same as the color of a designated corresponding portion of the original print data 100) is performed at the stage of intermediate data (here, “substantially the same” may not be completely the same and includes the state in which visual colors are regarded as being the same at an acceptable level). The above-described processing is performed by an intermediate data processing unit 15.

The intermediate data processing unit 15 performs, for intermediate data (in this example, a RunList) output from the RIP unit 13, processing of (1) merging of a spot color into process-color data, (2) insertion of an object representing an overprint portion, and (3) color conversion for intermediate data after object insertion is performed. In the example of FIG. 2, the intermediate data processing unit 15 first performs the processing of (1) merging of a spot color and (2) object insertion for the received intermediate data (RunList) 110 to generate intermediate data 120.

In the processing of (1) merging of a spot color, the color values of individual elements (individual runs in the case of a RunList) of the intermediate data specified using spot colors, the color values are converted into color values using process colors (in this example, CMYK). This conversion may be performed by referring to definition information of a spot color provided by a spot color ink manufacturer. Merging processing for converting the value of each pixel on raster data using a spot color into a value using a process color has been performed in the related arts, and merging of a spot color at the stage of intermediate data may be performed in a similar manner.

In the processing of (2) object insertion, the shape of an overlap portion where the normal object 202 and the spot-color object 204 that is overprinted on the normal object 202 overlap is calculated. The “shape” mentioned here includes information on the position (coordinates) of the overlap portion on a page image. That is, since the normal object 202 and the spot-color object 204 each include information on the position and shape thereof, the overlap portion where the normal object 202 and the spot-color object 204 overlap also include information on the position thereof. In the case where the RunList format is used, for example, by calculating the x coordinates of the left and right ends of a portion where a run of the normal object 202 and a run of the spot-color object 204 overlap on the same scanning line (that is, the same y coordinate), runs of the overlap portion for the scanning line are calculated. By calculating runs of the overlap portion for the entire distribution area of the normal object 202 and the spot-color object 204 in the y direction, the position and shape of the overlap portion where the normal object 202 and the spot-color object 204 overlap are calculated.

In the insertion processing, by combining the color value of the normal object 202 and the color value of the spot-color object 204 (both color values are represented by CMYK values) together, the color value of the overlap portion (represented using process colors) is calculated. The processing for calculating the color value of an overlap portion on the basis of the colors of upper and lower objects in the case of “execution of overprinting” has been performed in the related arts. In this exemplary embodiment, similar calculation may be performed for individual runs of an overlap portion.

When the shape (including positional information) and color value of the overlap portion are calculated as described above, an overlap portion object having the calculated shape and color value is inserted into the original intermediate data 110. Specifically, for example, the position, shape (y coordinate and x coordinates of left and right ends), and color value of each run of the overlap portion calculated as described above and described in the RunList format represent an overlap portion object 206, which represents the overlap portion where the normal object 202 and the spot-color object 204 overlap in the RunList format.

In this exemplary embodiment, the overlap portion object 206 is “inserted” (may be called “added”) into the original intermediate data 110 so as to be superimposed on the normal object 202 and the spot-color object 204 (for example, after the normal object 202 and the spot-color object 204 in a RunList) with designation of “knockout” (that is, “non-execution of overprinting”). Accordingly, the intermediate data 120 after object insertion is generated. Since “knockout” is designated, the colors of the underlying normal object 202 and spot-color object 204 in the overlap portion are ignored, and the color value of the overlap portion object 206 placed above the normal object 202 and the spot-color object 204 is rendered.

As described above, the intermediate data processing unit 15 converts overprinting of the normal object 202 and the spot-color object 204 into a combination of the normal object 202, the spot-color object 204, and the overlap portion object 206 superimposed on the normal object 202 and the spot-color object 204 with designation of knockout (however, the data details of the normal object 202 and the spot-color object 204 may not be changed, and the overlap portion object 206 may only be added with designation of knockout), as illustrated in FIG. 3.

The intermediate data processing unit 15 performs color conversion for printing by the printer 30 (for example, color calibration for matching the current color reproduction characteristics of the printer 30) for the intermediate data 120 after object insertion is performed. The color conversion is performed for the color values of individual runs included in the normal object 202, the spot-color object 204, and the overlap portion object 206 in the intermediate data 120. The processing of color conversion may be performed similarly to that performed in a related art.

The overlap portion object 206 before the color conversion is performed has the color obtained by combining the color of the normal object 202 and the spot-color object 204, and the color conversion is performed for the “composite color”. Thus, due to the nonlinear characteristics of color conversion, even in the case where color conversion is performed individually for colors to be superimposed and the color obtained by combining the color-converted colors is deviated from the original color (that is, visually the same color as the color of the overlap portion represented on the print data 100), such a deviation does not occur in this exemplary embodiment because color conversion is performed for the “composite color”.

In FIG. 2, the result of the color conversion is represented as the intermediate data 130. The intermediate data processing unit 15 outputs the intermediate data 130 to a rasterizing unit 17.

The rasterizing unit 17 generates the raster data 140C, 140M, 140Y, and 140K of process-color versions by rasterizing the received intermediate data 130. The rasterization processing may be performed similarly to that performed in a related art. For example, in the case where intermediate data is in the RunList format, individual runs may be rendered on a bitmap in the order from the front of a RunList of a page. At the time of rendering, the pixel value (color value) of a pixel corresponding to a portion where plural runs overlap may be calculated in accordance with designation of overprinting or knockout. Such calculation may be performed similarly to that performed in a related art. Here, since for an overlap portion for overprinting, the overlap portion object 206 is superimposed on the normal object 202 and the spot-color object 204 with designation of knockout, rendering is performed using the color value of the overlap portion object 206.

The raster data 140C, 140M, 140Y, and 140K of individual versions generated as described above are supplied via a data output unit 19 to the printer 30. The printer 30 controls a printing mechanism (for example, a printing engine of an electrophotographic system or an inkjet system) in accordance with the raster data 140C, 140M, 140Y, and 140K to print an image corresponding to the raster data 140C, 140M, 140Y, and 140K on paper.

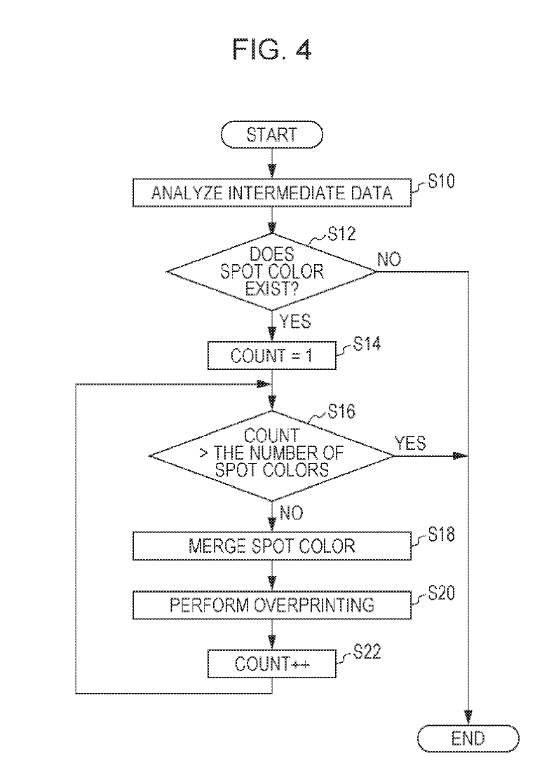

The overview of the processing for overprinting of a spot-color object according to this exemplary embodiment has been described above. An example of the flow of processing for merging a spot color and for inserting an overlap portion object to be performed for the overprinting processing by the intermediate data processing unit 15 will now be explained with reference to FIGS. 4 to 6.

The intermediate data processing unit 15 analyzes intermediate data in a page input from the RIP unit 13 (step S10). The intermediate data processing unit 15 determines, on the basis of the analysis, whether or not a spot color exists in the page (step S12). For example, in the case where a run in which a color value is specified using a spot color name exists in the intermediate data in the page, it is determined that a spot color exists in the page. Furthermore, on the basis of the analysis, the number of spot colors existing in the page is determined. The calculated total number of spot colors existing in the page (hereinafter, referred to as “the number of spot colors”) is used in a determination in step S16, which will be described below.

In the case where it is determined in step S12 that no spot color exists in the page (the determination in step S12 is negative “NO”), the intermediate data processing unit 15 terminates the processing illustrated in FIG. 4. In this case, only a normal object for which the color is specified using a process color exists in the intermediate data in the page, and the intermediate data processing unit 15 performs color conversion for the intermediate data.

Meanwhile, in the case where it is determined in step S12 that a spot color exists in the page, the value of a counter “COUNT” representing the number of spot colors is set to “1” (step S14), and the intermediate data processing unit 15 repeats the processing of steps S18 to S22 for all the spot colors included in the page (that is, until the fact that the value of the counter “COUNT” exceeds the number of spot colors in the page is detected).

Every time a spot color is detected from the intermediate data in the page, the intermediate data processing unit 15 performs the processing of steps S18 to S22 for the spot color. Here, it is assumed that a spot-color version is superimposed on a process-color (CMYK) version. In the case where plural spot colors exist, the order in which the plural spot-color versions overlap is defined. Spot colors in intermediate data in a page are detected in the order from the lowest to the uppermost spot-color versions in the overlapping arrangement (that is, from the spot-color version that is closest to a process-color version to the spot-color version that is furthest away from the process-color version).

In step S18, the target spot color in the intermediate data is merged into data of a process color (in this example, CMYK). That is, for all the runs in which the color value is represented using the spot color name of the spot color in the intermediate data, the color value using the spot color name is converted into a CMYK color value. This conversion may be performed by referring to definition information of the spot color provided by a spot color ink manufacturer.

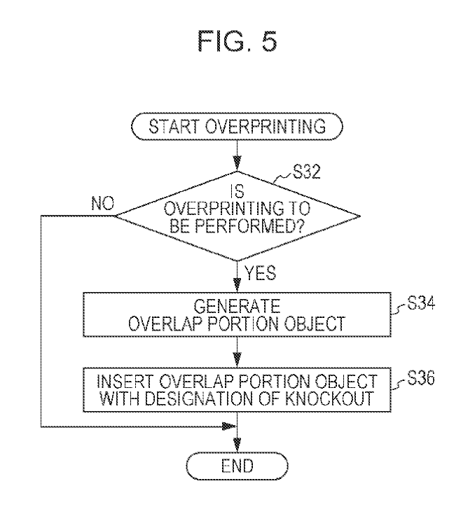

In step S20, the intermediate data processing unit 15 performs overprinting processing for the spot color. In the overprinting processing, an overlap portion object of an underlying object generated by overprinting of a spot-color object is added to the intermediate data. A detailed example of the overprinting processing will be explained later with reference to FIG. 5.

After the processing of step S20, the intermediate data processing unit 15 increases the value of the counter “COUNT” by 1 (step S22), and returns to step S16. Accordingly, the intermediate data processing unit 15 performs the processing of steps S18 to S22 for a spot color to be superimposed directly on the currently processed spot-color version in the intermediate data in the page (that is, a spot color that has not been processed in the processing of steps S18 to S22). After the processing of steps S18 to S22 is performed for all the spot colors in the page, the determination in step S16 becomes affirmative (the determination in step S16 is “YES”). Then, the intermediate data processing unit 15 terminates the processing illustrated in FIG. 4. At the time when the processing illustrated in FIG. 4 ends, all the objects in the intermediate data in the page are represented by CMYK values. The intermediate data processing unit 15 performs color conversion for the intermediate data so as to match the characteristics of the printer 30.

When the loop of steps S18 to S22 is passed through once, a spot color processed by the loop (referred to as a “first spot color”) is converted into a process color by the merging processing in step S18. Thus, in the processing loop of steps S18 to S22 for the subsequent color, the first-spot-color object is handled as a process-color object.

An example of the detailed procedure of the processing of step S20 (overprinting processing) of FIG. 4 will now be explained with reference to FIG. 5.

In this processing, the intermediate data processing unit 15 specifies all the objects of the current target spot color of the target intermediate data (that is, objects merged into the CMYK data in step S18), and performs processing of steps S32 to S36 for individual specified objects as targets (hereinafter, referred to as target spot-color objects).

In step S32, the intermediate data processing unit 15 determines whether or not overprinting for a target spot-color object is designated (whether or not “execution of overprinting” is designated). When overprinting is not designated, the intermediate data processing unit 15 terminates the processing illustrated in FIG. 5 without performing the processing of steps S34 to S36.

When overprinting is designated (the determination in step S32 is “YES”), the intermediate data processing unit 15 generates an overlap portion object representing an overlap portion where the target spot-color object and individual underlying objects overlap (step S34).

In the case where the first spot color (that is, the lowermost spot color in the overlapping arrangement) in the page is being processed, an underlying object group is a normal object group (that is, a group of objects for which color is specified using CMYK at the sage of PDL) in the page. In the case where the second spot color or the subsequent spot color is being processed, an underlying object group includes spot-color object group merged into CMYK in step S18 in the previously performed processing loop of steps S18 to S22 and an overlap portion object group added in step S20 in the previously performed processing loop of steps S18 to S22, as well as the normal object group.

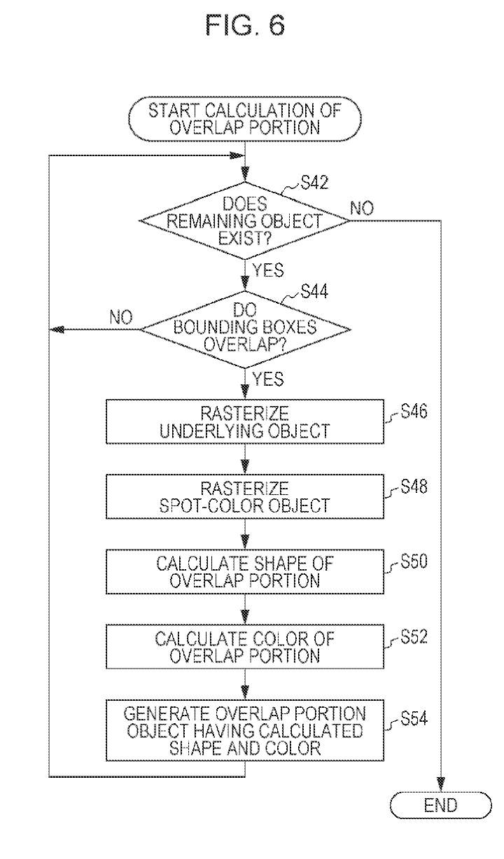

FIG. 6 illustrates an example of the details of the processing of step S34. In the procedure illustrated in FIG. 6, the intermediate data processing unit 15 determines whether or not an unprocessed underlying object (remaining object) exists in the underlying object group (step S42). When an unprocessed underlying object exists (the determination in step S42 is “YES”), the intermediate data processing unit 15 extracts one unprocessed underlying object, and determines whether or not the bounding box of the extracted unprocessed underlying object and the bounding box of the target spot-color object overlap (step S44). When the bounding boxes do not overlap, it is determined that objects existing within the boxes do not overlap. Thus, the intermediate data processing unit 15 returns to step S40 without performing the processing of steps S46 to S54, and searches for another unprocessed underlying object.

When it is determined in step S44 that the bounding boxes overlap (the determination in step S44 is “YES”), the intermediate data processing unit 15 rasterizes the underlying object (step S46), in this example. Then, the intermediate data processing unit 15 rasterizes the target spot-color object (step S48), and calculates the shape of the overlap portion where the underlying object and the target spot-color object overlap, on the basis of the results of the rasterization (step S50). When the intermediate data is in the RunList format, the intermediate data processing unit 15 may rasterize runs from data of the runs forming the target spot-color object and the underlying object in steps S46 and S48. In the case where a pixel of the target spot-color object and a pixel of the underlying object obtained by the rasterization in step S48 overlap, it is determined that the pixels form the overlap portion. A set of pixels determined to form the overlap portion form the shape of the overlap portion. By calculating intersection of runs on the same y coordinate forming the objects, instead of by performing rasterization, the overlap portion where the objects overlap may be calculated and a set of intersections on y coordinates may be defined as the shape of the overlap portion.

The intermediate data processing unit 15 calculates the color of the overlap portion calculated in step S50 (step S52). This color is a color obtained by overprinting the target spot-color object on the underlying object. The color to be obtained by overprinting processing may be calculated in a method employed in a related art. For example, the expression described below may be employed. For this expression, the spot-color blending ratio and the underlying-color blending ratio in overprinting may be set by a user, and the color value of an overlap portion is calculated using the set blending ratios.

(Color of overlap portion)=(Color of underlying object)×(Underlying-color blending ratio)+(Color of target spot-color object)×(spot-color blending ratio)

The underlying-color blending ratio and the spot-color blending ratio may be designated for individual spot colors. In this case, the blending ratios are included in attribute information of the spot-color object in the PDL data, and the attribute information is inherited by attribute information of the spot-color object in the intermediate data obtained by conversion from the PDL data. The intermediate data processing unit 15 may acquire the blending ratios from the attribute information of the spot-color object in the intermediate data and calculate the color of the overlap portion using the expression provided above.

Then, the intermediate data processing unit 15 generates an overlap portion object in the intermediate format having the shape and color of the overlap portion calculated in steps S50 and S52 (step S54). After the processing of step S54, the intermediate data processing unit 15 returns to step S42. When an unprocessed underlying object exists, the intermediate data processing unit 15 performs the processing of steps S44 to S54 for the underlying object. Accordingly, for all the underlying objects on which the target spot-color object is to be superimposed, overlap portion objects representing overlap portions where the target spot-color object and the underlying objects overlap are generated.

Referring back to FIG. 5, the intermediate data processing unit 15 inserts the individual overlap portion objects calculated in step S34 into the intermediate data in the page with a designation of knockout (step S36). In the object insertion processing, the overlap portion objects are inserted into the intermediate data so as to be superimposed on the target spot-color object (for example, the overlap portion object is arranged after the target spot-color object in the order in the intermediate data).

In this processing procedure, in the case where plural spot colors exist in a page, the color of an overlap portion for the uppermost spot color of the plural spot color is effective in the portion where the plural spot colors overlap.

After merging into CMYK (step S18) and insertion of overlap portion objects (step S20) for all the spot colors in the page are completed as described above, the intermediate data 120 illustrated in FIG. 2 is generated. Then, the intermediate data processing unit 15 performs color conversion for the intermediate data 120.

The controller 10 exemplified above is implemented, for example, when a program representing processing of the individual functional modules is executed by a general-purpose computer. Here, for example, the computer has, as hardware, a circuit configuration connected, for example, via a bus, to a microprocessor such as a central processing unit (CPU), a memory (for temporary storage) such as a random access memory (RAM) and a read only memory (ROM), a hard disk drive (HDD) controller for controlling an HDD, various input/output (I/O) interfaces, a network interface for controlling connection with a network such as a local area network, and the like. Furthermore, for example, a disk drive for reading from and/or writing to a portable disc recording medium such as a compact disc (CD) or a digital versatile dis (DVD), a memory reader/writer for reading from and/or writing to a portable nonvolatile recording medium of any specification such as a flash memory, or the like may be connected via an I/O interface to the bus. A program in which the processing details of the individual functions modules exemplified above are described is stored, via a recording medium such as a CD or a DVD or via network or the like, into a fixed storage device such as a hard disk drive and is installed into a computer. When the program stored in the fixed storage device is read to the RAM and is executed by the microprocessor such as the CPU, the functional module group exemplified above is implemented. Part or the entire functional module group may be configured as a hardware circuit such as a dedicated large scale integration (LSI), an application specific integrated circuit (ASIC), a field programmable gate array (FPGA), or a dynamic reconfigurable processor (DRP).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an object inserting unit that calculates, in a case where in print image data in which objects are each represented by a combination of position, shape, and color value, a designation for overprinting a first object whose color value is represented using a spot color on a second object whose color value is represented using a process color is made, the position and the shape of an overlap portion where the first object and the second objet overlap and a color value representing the color of the overlap portion using a process color, that generates a third object having the calculated position, shape, and color value, and that inserts the generated third object into the print image data with a designation of knockout;
a spot color converting unit that converts the color value of the first object in the print image data represented using the spot color into a color value represented using a process color; and
a color conversion processing unit that performs color conversion processing for the color values of the first object, the second object, and the third object in the print image data, the color values being represented using process colors, and that outputs the color-converted print image data.

2. The image processing apparatus according to claim 1, wherein in a case where a plurality of spot colors exist in the print image data, the object inserting unit and the spot color converting unit perform processing in an order from a lowest spot color in an overlapping arrangement of an image represented by the print image data, and the color conversion processing unit performs the color conversion processing for the print image data after the object inserting unit and the spot color converting unit perform the processing for all of the plurality of spot colors.

3. An image processing method comprising:
calculating, in a case where in print image data in which objects are each represented by a combination of position, shape, and color value, a designation for overprinting a first object whose color value is represented using a spot color on a second object whose color value is represented using a process color is made, the position and the shape of an overlap portion where the first object and the second objet overlap and a color value representing the color of the overlap portion using a process color, generating a third object having the calculated position, shape, and color value, and inserting the generated third object into the print image data with a designation of knockout;
converting the color value of the first object in the print image data represented using the spot color into a color value represented using a process color; and
performing color conversion processing for the color values of the first object, the second object, and the third object in the print image data, the color values being represented using process colors, and outputting the color-converted print image data.

4. A computer readable medium storing a program causing a computer to execute a process comprising:
calculating, in a case where in print image data in which objects are each represented by a combination of position, shape, and color value, a designation for overprinting a first object whose color value is represented using a spot color on a second object whose color value is represented using a process color is made, the position and the shape of an overlap portion where the first object and the second objet overlap and a color value representing the color of the overlap portion using a process color, generating a third object having the calculated position, shape, and color value, and inserting the generated third object into the print image data with a designation of knockout;
converting the color value of the first object in the print image data represented using the spot color into a color value represented using a process color; and
performing color conversion processing for the color values of the first object, the second object, and the third object in the print image data, the color values being represented using process colors, and outputting the color-converted print image data.
